(19) United States
(12) Patent Application Publication
(10) Pub. No.: US 2022/0180060 A1
(43) Pub. Date: Jun. 9, 2022

(54) CONTENT DRIVEN PREDICTIVE AUTO COMPLETION OF IT QUERIES

(71) Applicant: International Business Machines Corporation, Armonk, NY (US)

(72) Inventors: Akshay Jain, Albuquerque, NM (US); Ruchi Mahindru, Elmsford, NY (US); Soumitra Sarkar, Cary, NC (US); Shu Tao, Irvington, NY (US)

(21) Appl. No.: 17/115,933

(22) Filed: Dec. 9, 2020

(51) Int. Cl. G06F 40/274; G06F 40/205; G06N 3/08; G06F 17/16

(52) U.S. Cl. CPC G06F 40/274; G06F 17/16; G06N 3/08; G06F 40/205

(57) ABSTRACT

In an approach to content driven predictive auto completion of IT queries, an input phrase for an inquiry is received, where the input phrase is a sequence of words. Next words for the input phrase are predicted, where the prediction is based on a deep neural network model that has been trained with a corpus of documents for a specific domain. The next words are appended to the input phrase to create one or more predicted phrases. The predicted phrases are sorted, where the predicted phrases are sorted based on a similarity computation between the predicted phrases and the corpus of documents for the specific domain.

### BACKGROUND

The present invention relates generally to the field of information technology, and more particularly to content driven predictive auto completion of IT queries.

In general, a query is a form of questioning, in a line of inquiry. A query is often looking for an answer from an authority. A query can be a specific request for information from a database.

Autocomplete is a feature in which an application predicts the rest of a word or phrase a user is typing. In some smartphones, this is called predictive text. In graphical user interfaces, users can typically press the tab key to accept a suggestion or the down arrow key to accept one of several predicted phrases. Autocomplete speeds up human-computer interactions when it correctly predicts the word a user intends to enter after only a few characters or words have been typed into a text input field. Context completion is a feature which completes words, or entire phrases, based on the current context and context of other similar words within the same document corpus, or within some training data set. The main advantage of context completion is the ability to predict anticipated words more precisely. The main disadvantage is the need of a training data set, which is typically larger for context completion than for simpler word completion. In search engines, autocomplete user interface features provide users with suggested queries or results as they type their query in the search box. This is also commonly called autosuggest or incremental search. These search engines typically use large indices or popular query lists to perform the autocomplete function, since the corpus of possible documents the user is searching for is huge.

But there are problems with existing type-ahead text prediction systems. Search based frameworks such as Elasticsearch provide search query lookahead prediction using deterministic methods, such as creating data structures to represent common prefixes in text strings in documents which have been indexed for search. An example of such a data structure is a Minimal Deterministic Finite Automata (Minimal DFA). Such techniques do not work well if the user query involves terms not in the corpus of documents indexed by the search engine. Major search engines provide predictive type ahead using probabilistic models, typically based on deep learning techniques. Typical Internet search predictions are based on what other users are querying, while other systems like email autofill predictions are based on what sentences other users are typing in their emails.

In custom-built search systems for IT systems—for querying indexed technical documents—typical approaches for building interactive text prediction using probabilistic models will not work. For a new search system for a class of IT systems (e.g., personal computer support for a given manufacturer), there is initially very little query log content (contrast with an Internet search engine) for training a probabilistic model. Instead, the system for predicting queries typed into the custom search interface should be tailored to maximize the success of the query to yield good search results based on limited searchable content. The search system user may not be aware of the type of content ingested in the system, and may not be aware of how to craft the question to fetch the right document with high accuracy. In addition, the searchable corpus is typically too small in size to train a deep learning-based query prediction model. There is a need for a system for guiding the user through the process of constructing useful queries under the constraints of limited searchable content and minimal query history for model training.

### SUMMARY

Embodiments of the present invention disclose a method, a computer program product, and a system for content driven predictive auto completion of IT queries. In one embodiment, an input phrase for an inquiry is received, where the input phrase is a sequence of words. Next words for the input phrase are predicted, where the prediction is based on a deep neural network model that has been trained with a corpus of documents for a specific domain. The next words are appended to the input phrase to create one or more predicted phrases. The predicted phrases are sorted, where the predicted phrases are sorted based on a similarity computation between the predicted phrases and the corpus of documents for the specific domain.

In one embodiment, whether any next word of the one or more next words for the input phrase is an end of sentence is determined, where the end of sentence denotes that a specific phrase of the one or more predicted phrases is complete. Responsive to determining that any specific phrase of the predicted phrases is complete, the completed specific phrase is stored in a list of completed phrases. Responsive to determining that any specific phrase of the one or more predicted phrases is not complete, the next words are appended to the specific phrase of the predicted phrases that is not complete. One or more words are predicted for any specific phrase of the predicted phrases that is not complete.

In one embodiment, first predictions are received from a first system and second predictions are received from a second system. A first score is normalized for each first prediction and a second score is normalized for each second prediction. A plurality of prediction pairs is created, where each prediction pair includes a first prediction and a second prediction. A combined string similarity is calculated for each prediction pair based on the first score and the second score, where the string similarity is calculated using at least one of approximate matching and phrase similarity. A prediction weight is calculated, where the prediction weight is a mean of the combined string similarity for each prediction pair. A first normalized score of each first prediction is multiplied by the prediction weight to create a first weighted score for each first prediction. A second normalized score of each second prediction is multiplied by the prediction weight to create a second weighted score for each second prediction. The first predictions and the second predictions are merged into a prediction list, where the prediction list is sorted based on a descending order of the first weighted score and the second weighted score.

In one embodiment, each document in the corpus of documents is converted into a fixed length floating point vector, where the conversion is performed using a text encoder. A vector similarity is calculated for each document in the corpus of documents, where the vector similarity is a similarity computation between the predicted phrases and the fixed length floating point vector. The top query predictions are selected, where the top query predictions are the predicted phrases that have a highest similarity based on the vector similarity.

### BRIEF DESCRIPTION OF THE DRAWINGS

FIG. 1 is a functional block diagram illustrating a distributed data processing environment, in accordance with an embodiment of the present invention.

FIG. 2 is an example of training the next word prediction model, in accordance with an embodiment of the present invention.

FIG. 3 is an example of searching for query predictions using a next-word model, in accordance with an embodiment of the present invention.

FIG. 4 is a flowchart depicting operational steps for training the next word prediction model of the query autocompletion program, on a computing device within the distributed data processing environment of FIG. 1, for content driven predictive auto completion of IT queries, in accordance with an embodiment of the present invention.

FIG. 5 is a flowchart depicting operational steps for the phrase prediction function performed by the query autocompletion program, on a computing device within the distributed data processing environment of FIG. 1, for content driven predictive auto completion of IT queries, in accordance with an embodiment of the present invention.

FIG. 6 is a flowchart depicting operational steps for the ensemble function for combining results of two Query Autocomplete (QAC) systems performed by the query combining program, on a computing device within the distributed data processing environment of FIG. 1, for content driven predictive auto completion of IT queries, in accordance with an embodiment of the present invention.

FIG. 7 depicts a block diagram of components of the computing devices executing the query autocompletion program and the query combining program within the distributed data processing environment of FIG. 1, in accordance with an embodiment of the present invention.

### DETAILED DESCRIPTION

As explained above, there is a need for a system for guiding the user through the process of constructing useful queries under the constraints of limited searchable content and minimal query history for model training. The present invention addresses this issue with the goal of building a query prediction system, based on a partial user query typed into a search system, to maximize search accuracy. The query prediction, or Query Autocomplete (QAC) system uses a probabilistic model learning approach using a deep neural network. This Neural Query Autocomplete (N-QAC) system does not depend on past queries to learn a model. The N-QAC system learns a simple model, to only predict the next word given a currently typed partial user query, using the search system corpus. The N-QAC system is more practical than a full query prediction system given limited training data when the corpus of documents is limited to a narrow domain (e.g., personal computer support).

The next word prediction system is combined with a search mechanism, e.g., a beam search, to enumerate complete query prediction candidates. The N-QAC prediction candidates are further pruned by measuring their effectiveness in returning good search results from the corpus using neural information retrieval (IR) techniques.

In the present invention, a deep learning model is trained to predict the next word given an input phrase. This training data is generated from sentences in the corpus. In one embodiment, a contextual deep learning word embedding model, e.g., Bidirectional Encoder Representations from Transformers (BERT), is used to create vector representations (embeddings) of each word in an input phrase. The word embedding model is fine-tuned during the training of the full deep learning pipeline. The set of word embeddings (vectors) in the phrase is input to a deep learning sequence model, e.g., Recurrent Neural Network (RNN), Long Short Term Memory (LSTM), or Gated Recurrent Units (GRU), to create a vector representation of the input phrase. The phrase embedding is input to a dense feed forward neural network, i.e., a text classifier, the output of which predicts the next word in the phrase, one of IVI classes, each with a probability of the prediction being correct. As used here, the terminology IVI is defined as the number of words in the vocabulary. For example, if a corpus has a vocabulary of 300 words, then IVI is 300.

At query prediction time, to search for query predictions using a next-word model, the current set of words typed into the search system is input to the N-QAC system. The beam search system inputs the initial phrase typed by the user to the next-word predictor model, which has been trained offline using corpus sentences from the specific domain. The predictor predicts a set of single words which can follow the input phrase, each of which can be sorted in descending order using the probabilities associated with each next word prediction. The beam search component selects the top W predictions sorted by probabilities, where W is a pre-configured beam search width. The input phrase is then extended with each of the W next word predictions to create W input phrases which are each 1 word longer than the input. These steps are repeated with the W new (expanded) input phrases, yielding W×W new phrase predictions, each 1 word longer than the input phrases. Of these predictions, the top W are selected based on the new next word prediction probabilities.

If a next word for any of the W predictions is End of Sentence (EOS), that prediction is considered to be a full query prediction and is removed from the set of W phrase candidates for the next iteration, which is repeated with W-1 input phrases. This repeats until there are N query predictions (a preset threshold), or a maximum number of iterations of beam search (another preset threshold) is reached to limit the time spent on query predictions. In the final step, the output queries are re-sorted based on their effectiveness in yielding a good search result. This is achieved with a neural information retrieval (IR)-based filter.

The neural IR filter must perform a very quick check of the ‘goodness’ of a predicted query. It cannot be implemented by using the underlying IR system (e.g., Elasticsearch) to test each of the predicted queries, as this would be too slow. An efficient implementation involves preprocessing each corpus document, to extract sections which focus on a problem description, as opposed to solutions, prerequisites, or other extraneous detail. Technical documents (as opposed to open-ended web content) have implicit structure which makes this possible. For example, a technical problem report document will have an easily processable “problem” section. A hardware maintenance manual will have sections describing different types of repairs, each with a “problem” section. Each sentence in each “problem” section of each document in the corpus is converted into an embedding (a fixed length vector of floating point numbers). To compute the ‘goodness’ of N predicted queries against the corpus for ‘search efficiency’, a vector dot product between the N query vectors and C corpus “problem description” vectors is computed, which is the vector similarity. Alternate measures such as the arc vector similarity can also be computed.

For each of the N predicted queries, its highest similarity to any corpus sentence is computed. The top Q query predictions, with a lower bound of the best similarity measure between a query and any corpus sentence, is used to cut off entries in the final predicted query list. The result is a set of queries with the document with the best matching sentence and its similarity measure for each query.

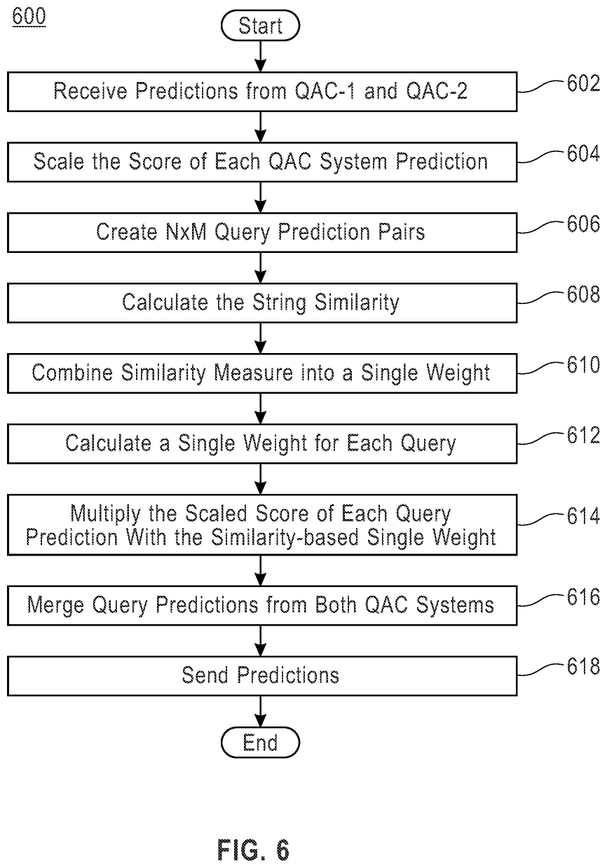

Other techniques can be utilized to improve the results of the N-QAC. A neural (N-QAC) model will work well when the user's input (partial) query includes one or more words not in the indexed corpus of the search engine. Similarly, a Deterministic Query Autocompletion (D-QAC) model based on data structures such as Minimal DFA will work better, and faster, if the user input query exactly matches a prefix of an indexed sentence. An ensemble model which combines the best of both techniques will be beneficial given that what a given user types into the search system cannot be known beforehand. The present invention includes a method for creating a QAC aggregator, which can select a set of query predictions from an N-QAC and a D-QAC system, and create a combined ordered list of query prediction to present to the user for each partial input query. This technique is explained in FIG. 6 below.

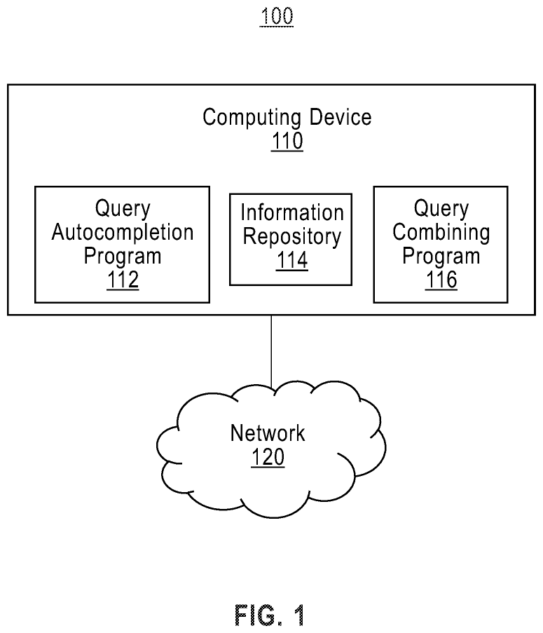

FIG. 1 is a functional block diagram illustrating a distributed data processing environment, generally designated 100, suitable for operation of query autocompletion program 112 and query combining program 116 in accordance with at least one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes computing device 110 connected to network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between computing device 110 and other computing devices (not shown) within distributed data processing environment 100.

Computing device 110 can be a standalone computing device, a management server, a web server, a mobile computing device, or any other electronic device or computing system capable of receiving, sending, and processing data. In an embodiment, computing device 110 can be a laptop computer, a tablet computer, a netbook computer, a personal computer (PC), a desktop computer, a personal digital assistant (PDA), a smart phone, or any programmable electronic device capable of communicating with other computing devices (not shown) within distributed data processing environment 100 via network 120. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers) that act as a single pool of seamless resources when accessed within distributed data processing environment 100.

In an embodiment, computing device 110 includes query autocompletion program 112 and query combining program 116. In an embodiment, query autocompletion program 112 and query combining program 116 are programs, applications, or subprograms of a larger program for content driven predictive auto completion of IT queries. In an alternative embodiment, query autocompletion program 112 and query combining program 116 may be located on any other device accessible by computing device 110 via network 120.

In an embodiment, computing device 110 includes information repository 114. In an embodiment, information repository 114 may be managed by query autocompletion program 112 or query combining program 116. In an alternate embodiment, information repository 114 may be managed by the operating system of the device, alone, or together with, query autocompletion program 112 or query combining program 116. Information repository 114 is a data repository that can store, gather, compare, and/or combine information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, corpus data, search data, training data, AI model data, classifier data, prediction data, user data, system configuration data, and other data that is received by query autocompletion program 112 and query combining program 116 from one or more sources, and data that is created by query autocompletion program 112 and query combining program 116.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, the information repository 114 may be implemented with any suitable storage architecture known in the art, such as a relational database, an object-oriented database, or one or more tables.

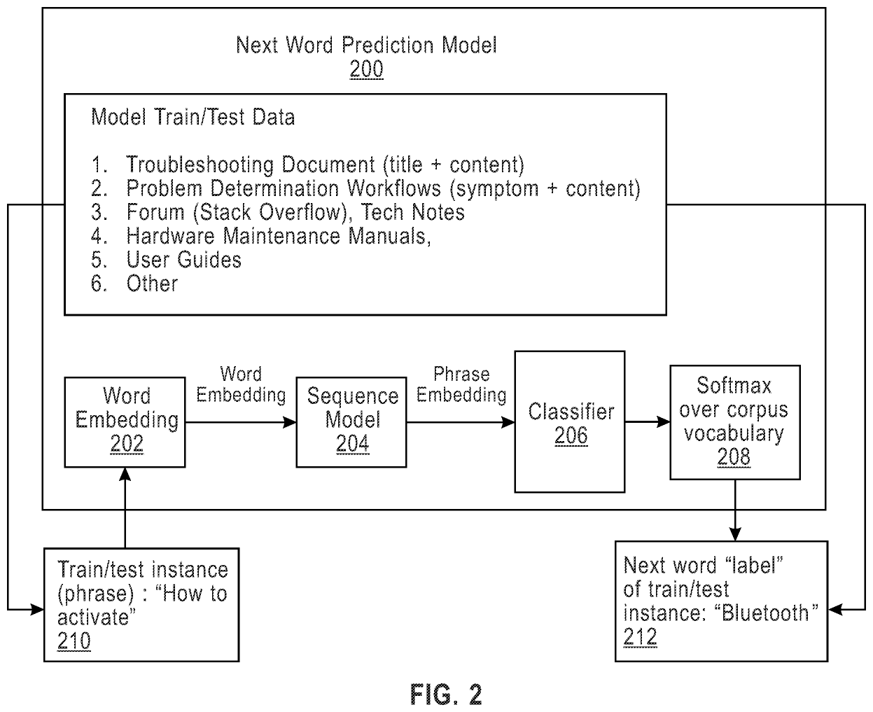

FIG. 2 is an example of training the next word prediction model, in accordance with an embodiment of the present invention. In this example, next word prediction model 200 is the existing art model that predicts the next word in the phrase based on the input phrase and the corpus of documents in the search index for a domain with a limited corpus. To train next word prediction model 200, training/test data is generated offline. In this example, train/test instance 210 is an input phrase that is specific to the domain of the system that is used to train the model. The input phrases, e.g., train/test instance 210, and next word label for each phrase that are used to train and test the neural network for next word prediction are derived from each sentence in the corpus. For example, for a sentence like “How to activate Bluetooth on your laptop”, train/test instances would look like this: <How, to>, <How to, activate>, <How to activate, Bluetooth>, etc.

Input train/test instance 210 is input into word embedding 202, a contextual deep learning word embedding model, e.g., BERT, that is used to create vector representations (i.e., embeddings) of each word in an input phrase. The set of word embeddings, or vectors, in the phrase is input to sequence model 204, a deep learning sequence model, e.g., RNN, LSTM, or GRU, to create a vector representation of the input phrase. Next, the phrase embedding is input to classifier 206, a dense feed forward neural network, i.e., a text classifier, the output of which predicts the next word in the phrase, one of IVI classes, each with a probability. The output of classifier 206 is passed to softmax over corpus vocabulary 208, and a softmax function is run over the corpus vocabulary for the specific domain. A softmax function transforms the output of the classifier into values between 0 and 1, so that they can be interpreted as probabilities. Based on the probabilities calculated in softmax over corpus vocabulary 208, the highest probability next word is predicted, in this example the predicted word is “Bluetooth”.

Next word label of train/test instance 212 is the output of the model. During training, the next word label of train/test instance 212 is compared to the actual next word in the training data, and any error is fed back to the neural network for adjusting its weights via back propagation.

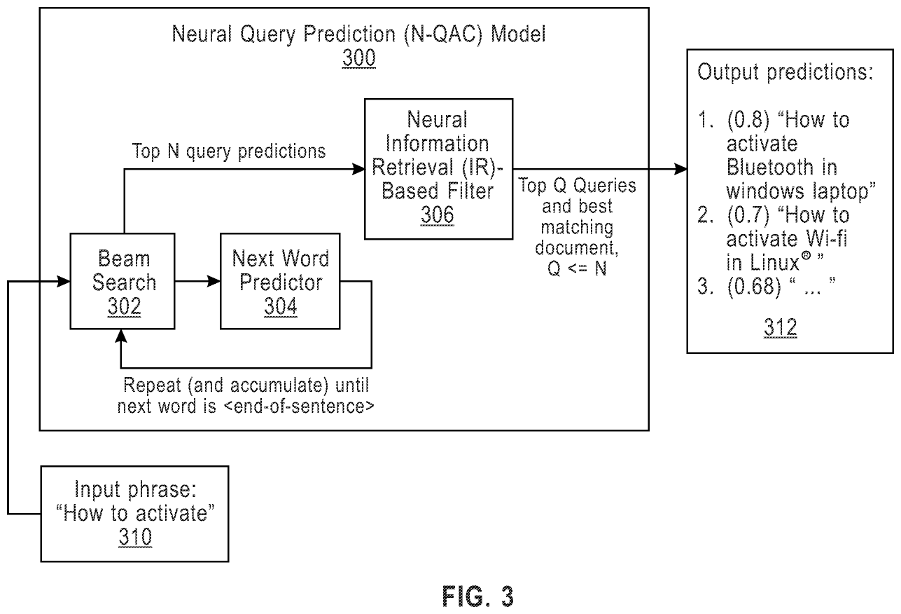

FIG. 3 is an example of searching for query predictions using a next-word model, in accordance with an embodiment of the present invention. Neural Query Prediction (N-QAC) Model 300 is the section of query autocompletion program 112 that predicts the completion of the phrase based on the input phrase and the corpus of documents in the search index for a domain with a limited corpus. In this example, input phrase 310, a partial query from the end user, is input into beam search 302. A beam search is a heuristic search algorithm that explores a graph by expanding the most promising node in a limited set. Initially, the beam search system inputs the phrase to next-word predictor 304, which is the model trained offline using corpus sentences, e.g., next word prediction model 200 from FIG. 2. Beam search 302 selects the top W predictions sorted by probabilities. W is the (pre-configured) beam search width, which is five for this example. In this example, beam search 302 extends the input phrase with each of the five predictions to create five input phrases which are each one word longer than the input.

The five new predictions are then input back into next word predictor 304, and the cycle continues until the output of next word predictor 304 is an End of Sentence (EoS). The EoS is a word or character that indicates that a particular prediction has no additional words to add to the current phrase based on the output of the next word predictor. The EoS is added to each sentence during training. Next word predictor 304 predicts a set of next words, each of which can follow a given input phrase, where each next word is one of IVI words in the corpus vocabulary, and the next word predictions can be sorted in descending order using the probabilities associated with each prediction. Beam search 302 and next word predictor 304 are repeated with the five new (expanded) input phrases, yielding W×W (25 in this example) new phrase predictions, each one word longer than the input phrase. Of these predictions, the top five are selected based on the new next word prediction probabilities. If a next word is EoS, that is considered to be a full query prediction and is removed from the set of W candidates for the next iteration, which is repeated with W-1 input phrases. The removed query prediction is moved to temporary storage until all the query predictions are complete. This repeats until there are N query predictions (a preset threshold), or a maximum number of iterations of beam search is reached (also a preset threshold) to limit the time spent on query predictions.

In the final step, the output queries are re-sorted based on their effectiveness in yielding a good search result by neural information retrieval (IR)-based filter 306. Neural IR filter 306 uses neural embedding-based similarity measures to select the predicted queries that will yield the “best possible” information from the corpus. The output queries are then returned to the user as output predictions 312.

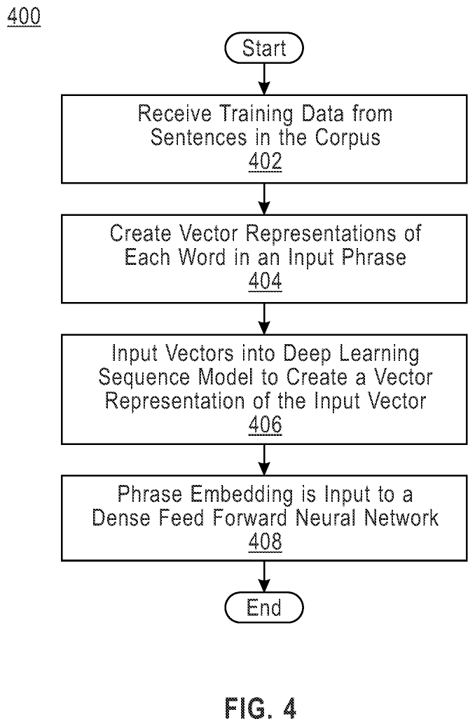

FIG. 4 is a flowchart depicting operational steps for training the next word prediction model of the query autocompletion program, for content driven predictive auto completion of IT queries, in accordance with an embodiment of the present invention. In an alternative embodiment, the steps of workflow 400 may be performed by any other program while working with query autocompletion program 112. In an embodiment, training data is generated offline in a preprocessing phase. In an embodiment, query autocompletion program 112 receives the training data and inputs it into the next word prediction model to train the model. In an embodiment, query autocompletion program 112 uses a pretrained contextual deep learning word embedding model, e.g., BERT, to create vector representations, i.e., embeddings, of each word in an input phrase. In an embodiment, query autocompletion program 112 inputs the set of word embeddings, or vectors, from the phrase into a deep learning sequence model, e.g., RNN, LSTM, or GRU, to create a vector representation of the input phrase. In an embodiment, query autocompletion program 112 inputs the phrase embedding into the dense feed forward neural network, i.e., a text classifier, the output of which predicts the next word in the phrase, one of IVI classes where IVI is the number of words in the corpus, each with a probability.

It should be appreciated that embodiments of the present invention provide at least for content driven predictive auto completion of IT queries. However, FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

Query autocompletion program 112 receives training data from sentences in the corpus (step 402). In an embodiment, a training dataset is generated offline in a preprocessing phase. In an embodiment, training data is extracted from the domain content sentences as at least one of one or more n-grams, one of one or more first natural language phrases based on a deep parsing, one of one or more second natural language phrases based on a semantic role labeling, or one of one or third more natural language phrases based on an Abstract Meaning Representation (AMR). In an embodiment, query autocompletion program 112 receives the training data and inputs it into the next word prediction model to train the model. In an embodiment, the trained model is used by query autocompletion program 112, along with a search function, to create the query autocompletion service.

Query autocompletion program 112 creates vector representations of each word in an input phrase (step 404). In an embodiment, query autocompletion program 112 uses a pretrained contextual deep learning word embedding model, e.g., BERT, to create vector representations, i.e., embeddings, of each word in an input phrase. In an embodiment, query autocompletion program 112 may fine-tune the word embedding model during the training. In an embodiment, to fine-tune the word embedding model, the output of the model is compared to the actual next word in the training data, and any prediction error is fed back to the neural network for adjusting its weights via back propagation, including the neural network weights of the word embedding model (e.g., BERT) itself.

Query autocompletion program 112 inputs word embedding vectors into the deep learning sequence model to create a vector representation of the input phrase (step 406). In an embodiment, query autocompletion program 112 inputs the set of word embeddings, or vectors, from the phrase into a deep learning sequence model, e.g., RNN, LSTM, or GRU, to create a vector representation of the input phrase.

Query autocompletion program 112 phrase embedding is input into a dense feed forward neural network (step 408). In an embodiment, a dense feed forward neural network is an existing neural network architecture for training a deep learning model to predict an output belonging to one of many classes, given an input. In an embodiment, query autocompletion program 112 inputs the phrase embedding into the dense feed forward neural network, i.e., a text classifier, the output of which predicts the next word in the phrase, one of IVI classes where IVI is the number of words in the corpus, each with a probability. In an embodiment, since the actual next word for each input phrase is known when the training data is prepared from the corpus sentences, the actual output from the dense feed forward neural network is compared to the expected output from the training data to validate the output, and update the network to correct for any prediction error.

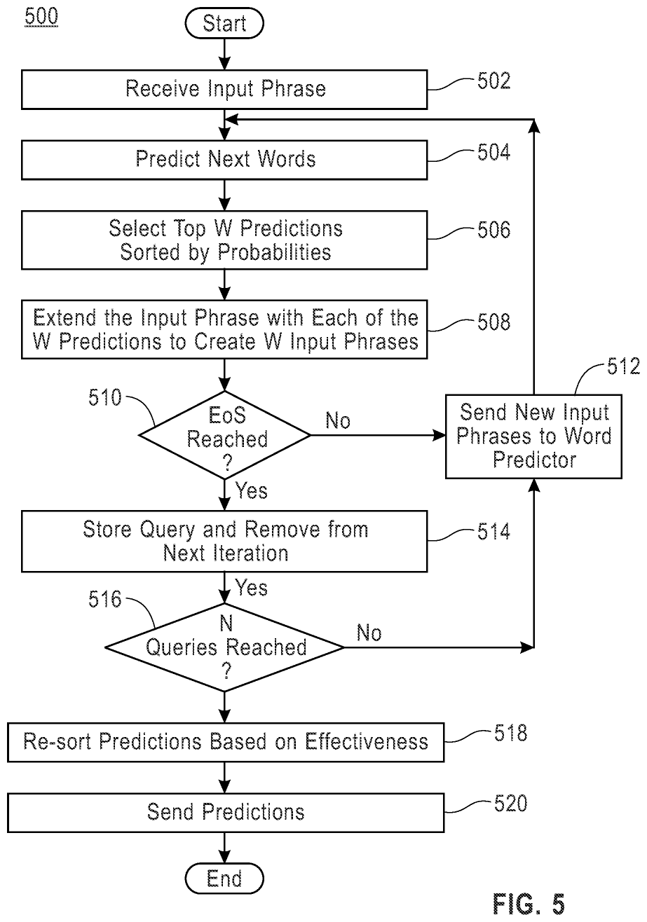

FIG. 5 is a flowchart for the steps for the query autocompletion program, for content driven predictive auto completion of IT queries, in accordance with an embodiment of the present invention. In an alternative embodiment, the steps of workflow 500 may be performed by any other program while working with query autocompletion program 112. In an embodiment, query autocompletion program 112 receives the current set of words typed into the search system as input to the N-QAC system. In an embodiment, query autocompletion program 112 inputs the phrase to the next-word predictor model trained in FIG. 4 using corpus sentences. In an embodiment, query autocompletion program 112 selects the top W predictions sorted by probabilities. In an embodiment, query autocompletion program 112 extends the input phrase with each of the W predictions to create W input phrases which are each one word longer than the input. In an embodiment, query autocompletion program 112 determines if the next word is an EoS. In an embodiment, if query autocompletion program 112 determines that the EoS was not reached, then query autocompletion program 112 returns to the earlier step to predict the next word. In an embodiment, if query autocompletion program 112 determines that the EoS was reached for one of the predicted phrases, then query autocompletion program 112 temporarily stores the completed phrase until all the phrase predictions are complete for this prediction cycle. In an embodiment, query autocompletion program 112 determines if the predetermined number of queries, i.e., N queries, to be created has been reached. In an embodiment, if query autocompletion program 112 determines that N queries have not been reached, then query autocompletion program 112 returns to the earlier step to send the new input phrases to the word predictor. In an embodiment, if query autocompletion program 112 determines that the predetermined number of queries to be created has been reached, then query autocompletion program 112 re-sorts the output queries based on their effectiveness in yielding a good search result by using a neural IR-based filter, e.g., neural IR-based filter 306 from FIG. 3. In an embodiment, query autocompletion program 112 sends the predictions to the user.

It should be appreciated that embodiments of the present invention provide at least for content driven predictive auto completion of IT queries. However, FIG. 5 provides only an illustration of one implementation and does not imply any limitations with regard to the environments in which different embodiments may be implemented. Many modifications to the depicted environment may be made by those skilled in the art without departing from the scope of the invention as recited by the claims.

Query autocompletion program 112 receives an input phrase (step 502). In an embodiment, query autocompletion program 112 receives the current set of words typed into the search system as input to the N-QAC system. In an embodiment, the words are received as they are input by a user.

Query autocompletion program 112 predicts the next words (step 504). In an embodiment, query autocompletion program 112 inputs the phrase to the next-word predictor model trained in FIG. 4 using corpus sentences. In an embodiment, the predictor predicts one of the next IVI words, where IVI is the number of words in the corpus, which can be sorted in descending order using the probabilities associated with each next word prediction. In an embodiment, the predictor is a classifier. In an embodiment, the output class for an input phrase is one of the IVI possible classes (or next words). Each predicted next word is from the corpus dictionary, where the dictionary is the list of all words in the corpus.

Query autocompletion program 112 selects the top W predictions sorted by probabilities (step 506). In an embodiment, query autocompletion program 112 selects the top W predictions sorted by probabilities. In an embodiment, W is the width of the beam search, e.g., beam search 302 from FIG. 3. In an embodiment, the beam width is a preconfigured value.

Query autocompletion program 112 extends the input phrase with each of the W predictions to create W input phrases (step 508). In an embodiment, query autocompletion program 112 extends the input phrase with each of the W predictions to create W phrases which are each one word longer than the input. For example, if the initial input phrase is three words long, and the beam width is five, then query autocompletion program 112 extends the initial input phrase with each of the five predictions to create five predicted phrases, each four words long. In an embodiment, after the initial input phrase has been processed, query autocompletion program 112 performs each additional iteration on the W predicted phrases, yielding W×W (25 in this example) new phrase predictions, each one word longer than the input phrase. Of these predictions, the top W (5 in this example) are selected based on the new next word prediction probabilities.

Query autocompletion program 112 determines if the EoS is reached (decision block 510). In an embodiment, query autocompletion program 112 determines if the next word, i.e., any of the W predictions from step 508, is an EoS. In an embodiment, the EoS is a word or character that indicates that a particular prediction has no additional words to add to the current phrase based on the output of the next word predictor. In an embodiment, the EoS is added to each sentence during training.

If query autocompletion program 112 determines that the EoS was reached (“yes” branch, decision block 510), then query autocompletion program 112 proceeds to step 514. If query autocompletion program 112 determines that the EoS was not reached (“no” branch, decision block 510), then query autocompletion program 112 returns to step 504 to predict the next word. Note that decision block 510 applies to each prediction of the W predictions, i.e., each prediction proceeds to step 504 if that prediction does not reach the EoS, or to step 514 if that prediction does reach the EoS.

Query autocompletion program 112 sends the new input phrases to the word predictor (step 512). In an embodiment, query autocompletion program 112 returns to step 504 with the new phrases constructed in step 508 that did not reach the EoS as the input to the word predictor. In this way, query autocompletion program 112 iteratively builds the predicted query phrases until the full phrase is built for each prediction. Query autocompletion program 112 then returns to step 504 to predict the next word.

Query autocompletion program 112 stores the query and removes it from the next iteration (step 514). In an embodiment, if query autocompletion program 112 determines that the EoS was reached for one of the predicted phrases in decision block 510, then query autocompletion program 112 temporarily stores the completed phrase until all the phrase predictions are complete for this prediction cycle. Note that the phrases that did reach the EoS are not fed back to step 504.

Query autocompletion program 112 determines if N queries have been reached (decision block 516). In an embodiment, query autocompletion program 112 determines if the predetermined number of queries, i.e., N queries, to be created has been reached. If query autocompletion program 112 determines that the predetermined number of queries to be created has not been reached, then query autocompletion program 112 returns to step 512 to send the query back into the next word predictor. In an embodiment, query autocompletion program 112 may stop the iteration if a pre-determined maximum number of iterations of the algorithm to predict queries has been reached (in this case, N is the pre-determined number of iterations). This ensures that query autocompletion program 112 does not spend too much time predicting queries (while the end user waits).

If query autocompletion program 112 determines that N queries have been reached (“yes” branch, decision block 516), then query autocompletion program 112 proceeds to step 518. If query autocompletion program 112 determines that N queries have not been reached (“no” branch, decision block 516), then query autocompletion program 112 returns to step 512 to send the new input phrases to the word predictor.

Query autocompletion program 112 re-sorts the predictions based on their effectiveness (step 518). In an embodiment, if query autocompletion program 112 determines that the predetermined number of queries to be created has been reached, then query autocompletion program 112 re-sorts the output queries based on their effectiveness in yielding a good search result by using a neural IR-based filter, e.g., neural IR-based filter 306 from FIG. 3.

Query autocompletion program 112 sends the predictions (step 520). In an embodiment, query autocompletion program 112 sends the predictions to the user.

FIG. 6 is a flowchart depicting operational steps for the ensemble function for combining results of two QAC services performed by the query combining program, on a computing device within the distributed data processing environment of FIG. 1, for content driven predictive auto completion of IT queries, in accordance with an embodiment of the present invention. In an alternative embodiment, the steps of workflow 600 may be performed by any other program while working with query combining program 116. In an embodiment, query combining program 116 receives the input phrases and the resulting predictions from the two query autocompletion systems, QAC-1 and QAC-2. In an embodiment, query combining program 116 normalizes the score of each QAC system prediction so that the predicted query scores are in the range between 0.0 and 1.0. In an embodiment, query combining program 116 creates N×M query prediction pairs, one from each QAC service, using N query predictions from QAC-1 and M query predictions from QAC-2. In an embodiment, query combining program 116 calculate the string similarity between each query prediction pair using one or more of approximate string matching algorithms, phrase similarity using pretrained sentence embedding models, or other techniques. In an embodiment, query combining program 116 combines the similarity measures for each of the N×M query prediction pairs into a single weight. In an embodiment, each of the N query predictions of QAC-1 will have M weights, and each of the M query predictions of QAC-2 will have N weights. In an embodiment, query combining program 116 multiplies the normalized score of each query prediction with the similarity-based single weight calculated in the previous step. In an embodiment, query combining program 116 sorts the query predictions from both QAC systems by the score calculated in the previous step. In an embodiment, query combining program 116 sends the predictions to the user in order of descending scores.

It should be appreciated that embodiments of the present invention provide at least for content driven predictive auto completion of IT queries. However, FIG. 6 provides only an illustration of one implementation and does not imply any limitations with regard to the environments in which different embodiments may be implemented. Many modifications to the depicted environment may be made by those skilled in the art without departing from the scope of the invention as recited by the claims.

Query combining program 116 receives predictions from QAC-1 and QAC-2 (step 602). In an embodiment, query combining program 116 receives the input phrases and the resulting predictions from the two query autocompletion systems, QAC-1 and QAC-2.

Query combining program 116 normalizes the score of each QAC system prediction (step 604). In an embodiment, query combining program 116 normalizes the score of each QAC system prediction so that the top score is 1.0, and the other scores are normalized proportionately. This guarantees that the scores assigned to query predictions by disparate QAC services are comparable.

Query combining program 116 creates N×M query prediction pairs (step 606). In an embodiment, query combining program 116 creates N×M query prediction pairs, where each of the N×M query prediction pairs contains one prediction from each QAC service, using N query predictions from QAC-1 and M query predictions from QAC-2.

Query combining program 116 calculates the string similarity (step 608). In an embodiment, query combining program 116 calculate the string similarity between each query prediction pair using at least one of approximate string matching algorithms, phrase similarity using pretrained sentence embedding models, or other techniques.

Query combining program 116 combines the similarity measures into a single weight (step 610). In an embodiment, query combining program 116 combines the similarity measures for each of the N×M query prediction pairs into a single weight. In an embodiment, each similarity measure is a number between 0 and 1.0. In an embodiment, query combining program 116 combines the similarity measure using an appropriate method, e.g., mean( ).

Query combining program 116 calculates a single weight for each query (step 612). In an embodiment, each of the N query predictions of QAC-1 will have M weights, and each of the M query predictions of QAC-2 will have N weights. In an embodiment, for each query, query combining program 116 calculates a single weight using, for example, mean( ).

Query combining program 116 multiplies the normalized score of each query prediction with the similarity-based single weight (step 614). In an embodiment, query combining program 116 multiplies the normalized score of each query prediction with the similarity-based single weight calculated in step 610. The result is that each normalized query prediction score is normalized by the similarity-based single weight.

Query combining program 116 merges the query predictions from both QAC systems (step 616). In an embodiment, query combining program 116 sorts the query predictions from both QAC systems by the score calculated in step 614. In an embodiment, query combining program 116 merges the query predictions from both QAC systems based on the sort order.

Query combining program 116 sends the predictions (step 618). In an embodiment, query combining program 116 sends the predictions to the user in order of descending scores.

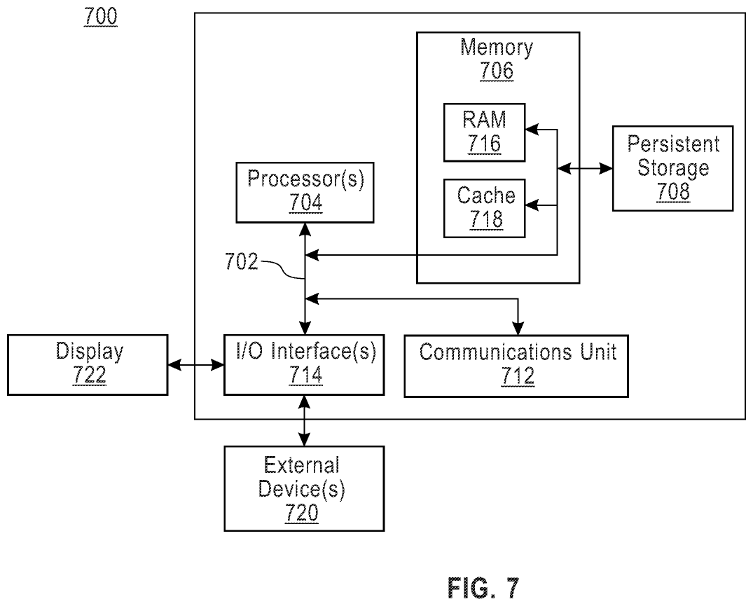

FIG. 7 is a block diagram depicting components of computing device 110 suitable for query autocompletion program 112 and query combining program 116, in accordance with at least one embodiment of the invention. FIG. 7 displays computer 700; one or more processor(s) 704 (including one or more computer processors); communications fabric 702; memory 706, including random-access memory (RAM) 716 and cache 718; persistent storage 708; communications unit 712; I/O interfaces 714; display 722; and external devices 720. It should be appreciated that FIG. 7 provides only an illustration of one embodiment and does not imply any limitations with regard to the environments in which different embodiments may be implemented. Many modifications to the depicted environment may be made.

As depicted, computer 700 operates over communications fabric 702, which provides communications between computer processor(s) 704, memory 706, persistent storage 708, communications unit 712, and I/O interface(s) 714. Communications fabric 702 may be implemented with any architecture suitable for passing data or control information between processors 704 (e.g., microprocessors, communications processors, and network processors), memory 706, external devices 720, and any other hardware components within a system. For example, communications fabric 702 may be implemented with one or more buses.

Memory 706 and persistent storage 708 are computer readable storage media. In the depicted embodiment, memory 706 comprises RAM 716 and cache 718. In general, memory 706 can include any suitable volatile or non-volatile computer readable storage media. Cache 718 is a fast memory that enhances the performance of processor(s) 704 by holding recently accessed data, and near recently accessed data, from RAM 716.

Program instructions for query autocompletion program 112 and query combining program 116 may be stored in persistent storage 708, or more generally, any computer readable storage media, for execution by one or more of the respective computer processors 704 via one or more memories of memory 706. Persistent storage 708 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer readable storage medium that is also part of persistent storage 708.

Communications unit 712, in these examples, provides for communications with other data processing systems or devices. In these examples, communications unit 712 includes one or more network interface cards. Communications unit 712 may provide communications through the use of either or both physical and wireless communications links. In the context of some embodiments of the present invention, the source of the various input data may be physically remote to computer 700 such that the input data may be received, and the output similarly transmitted via communications unit 712.

I/O interface(s) 714 allows for input and output of data with other devices that may be connected to computer 700. For example, I/O interface(s) 714 may provide a connection to external device(s) 720 such as a keyboard, a keypad, a touch screen, a microphone, a digital camera, and/or some other suitable input device. External device(s) 720 can also include portable computer readable storage media such as, for example, thumb drives, portable optical or magnetic disks, and memory cards. Software and data used to practice embodiments of the present invention, e.g., query autocompletion program 112 and query combining program 116, can be stored on such portable computer readable storage media and can be loaded onto persistent storage 708 via I/O interface(s) 714. I/O interface(s) 714 also connect to display 722.

Display 722 provides a mechanism to display data to a user and may be, for example, a computer monitor. Display 722 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for predictive auto completion, the computer-implemented method comprising:
receiving, by one or more computer processors, an input phrase for an inquiry, wherein the input phrase is a sequence of words;
predicting, by the one or more computer processors, one or more next words for the input phrase, wherein the prediction is based on a deep neural network model that has been trained with a corpus of documents for a specific domain;
appending, by the one or more computer processors, the one or more next words to the input phrase to create one or more predicted phrases; and
sorting, by the one or more computer processors, the one or more predicted phrases, wherein the one or more predicted phrases are sorted based on a similarity computation between the one or more predicted phrases and the corpus of documents for the specific domain.

2. The computer-implemented method of claim 1, wherein appending the one or more next words to the input phrase to create the one or more predicted phrases comprises:
determining, by the one or more computer processors, whether any next word of the one or more next words for the input phrase is an end of sentence, wherein the end of sentence denotes that a specific phrase of the one or more predicted phrases is complete;
responsive to determining that any specific phrase of the one or more predicted phrases is complete, storing, by the one or more computer processors, the completed any specific phrase in a list of completed phrases;
responsive to determining that any specific phrase of the one or more predicted phrases is not complete, appending, by the one or more computer processors, the one or more next words to the any specific phrase of the one or more predicted phrases that is not complete; and
predicting, by the one or more computer processors, one or more next words for the any specific phrase of the one or more predicted phrases that is not complete.

3. The computer-implemented method of claim 1, wherein predicting the one or more next words for the input phrase, wherein the prediction is based on the deep neural network model that has been trained with the corpus of documents for the specific domain further comprises:
generating, by the one or more computer processors, training data from a plurality of sentences in the corpus of documents for the specific domain;
creating, by the one or more computer processors, a word vector representation for each word of one or more words in a training phrase;
inputting, by the one or more computer processors, the word vector representation for each word of one or more words in the training phrase into a deep learning sequence model to create a phrase vector representation of the training phrase; and
inputting, by the one or more computer processors, the phrase vector representation of the training phrase into the deep neural network model.

4. The computer-implemented method of claim 3, wherein generating training data from the plurality of sentences in the corpus of documents for the specific domain further comprises:
receiving, by the one or more computer processors, a plurality of domain content sentences from the corpus of documents from the specific domain;
extracting, by the one or more computer processors, the plurality of domain content sentences as at least one of one or more n-grams, one of one or more first natural language phrases based on a deep parsing, one of one or more second natural language phrases based on a semantic role labeling, and one of one or third more natural language phrases based on an abstract meaning representation;
filtering, by the one or more computer processors, the plurality of domain content sentences for at least one of a sequence-to-sequence model and a language model; and
preparing, by the one or more computer processors, a training dataset with a plurality of phrases of different length and an expected next word, wherein the plurality of phrases and the next word are not directly extracted from the plurality of domain content sentences.

5. The computer-implemented method of claim 1, wherein sorting the one or more predicted phrases, wherein the one or more predicted phrases are sorted based on the similarity computation between the one or more predicted phrases and the corpus of documents for the specific domain further comprises:
receiving, by the one or more computer processors, one or more first predictions from a first system and one or more second predictions from a second system;
normalizing, by the one or more computer processors, a first score for each first prediction of the one or more first predictions and a second score for each second prediction of the one or more second predictions;
creating, by the one or more computer processors, a plurality of prediction pairs, wherein each prediction pair includes a first prediction from the one or more first predictions and a second prediction from the one or more second predictions;
calculating, by the one or more computer processors, a combined string similarity for each prediction pair of the plurality of prediction pairs based on the first score and the second score, wherein the string similarity is calculated using at least one of approximate matching and phrase similarity;
calculating, by the one or more computer processors, a prediction weight, wherein the prediction weight is a mean of the combined string similarity for each prediction pair of the plurality of prediction pairs;
multiplying, by the one or more computer processors, a first normalized score of each first prediction of the one or more first predictions by the prediction weight to create a first weighted score for each first prediction;
multiplying, by the one or more computer processors, a second normalized score of each second prediction of the one or more second predictions by the prediction weight to create a second weighted score for each second prediction; and
merging, by the one or more computer processors, the one or more first predictions and the one or more second predictions into a prediction list, wherein the prediction list is sorted based on a descending order of the first weighted score and the second weighted score.

6. The computer-implemented method of claim 1, wherein sorting the one or more predicted phrases, wherein the one or more predicted phrases are sorted based on the similarity computation between the one or more predicted phrases and the corpus of documents for the specific domain further comprises:
converting, by the one or more computer processors, each document in the corpus of documents into a fixed length floating point vector, wherein the conversion is performed using a text encoder;
calculating, by the one or more computer processors, a vector similarity for each document in the corpus of documents, wherein the vector similarity is a similarity computation between the one or more predicted phrases and the fixed length floating point vector; and
selecting, by the one or more computer processors, one or more top query predictions, wherein the one or more top query predictions are the one or more predicted phrases that have a highest similarity based on the vector similarity.

7. The computer-implemented method of claim 1, further comprising:
selecting, by the one or more computer processors, a subset of the one or more predicted phrases, wherein a size of the subset is a predetermined number; and
sending, by the one or more computer processors, the subset of the one or more predicted phrases to a user.

8. A computer program product for predictive auto completion, the computer program product comprising one or more computer readable storage media and program instructions stored on the one or more computer readable storage media, the program instructions including instructions to:
receive an input phrase for an inquiry, wherein the input phrase is a sequence of words;
predict one or more next words for the input phrase, wherein the prediction is based on a deep neural network model that has been trained with a corpus of documents for a specific domain;
append the one or more next words to the input phrase to create one or more predicted phrases; and
sort the one or more predicted phrases, wherein the one or more predicted phrases are sorted based on a similarity computation between the one or more predicted phrases and the corpus of documents for the specific domain.

9. The computer program product of claim 8, wherein append the one or more next words to the input phrase to create the one or more predicted phrases comprises one or more of the following program instructions, stored on the one or more computer readable storage media, to:
determine whether any next word of the one or more next words for the input phrase is an end of sentence, wherein the end of sentence denotes that a specific phrase of the one or more predicted phrases is complete;
responsive to determining that any specific phrase of the one or more predicted phrases is complete, store the completed any specific phrase in a list of completed phrases;
responsive to determining that any specific phrase of the one or more predicted phrases is not complete, append the one or more next words to the any specific phrase of the one or more predicted phrases that is not complete; and
predict one or more next words for the any specific phrase of the one or more predicted phrases that is not complete.

10. The computer program product of claim 8, wherein predict the one or more next words for the input phrase, wherein the prediction is based on the deep neural network model that has been trained with the corpus of documents for the specific domain further comprises one or more of the following program instructions, stored on the one or more computer readable storage media, to:
generate training data from a plurality of sentences in the corpus of documents for the specific domain;
create a word vector representation for each word of one or more words in a training phrase;
input the word vector representation for each word of one or more words in the training phrase into a deep learning sequence model to create a phrase vector representation of the training phrase; and
input the phrase vector representation of the training phrase into the deep neural network model.

11. The computer program product of claim 10, wherein generate training data from the plurality of sentences in the corpus of documents for the specific domain further comprises one or more of the following program instructions, stored on the one or more computer readable storage media, to:
receive a plurality of domain content sentences from the corpus of documents from the specific domain;
extract the plurality of domain content sentences as at least one of one or more n-grams, one of one or more first natural language phrases based on a deep parsing, one of one or more second natural language phrases based on a semantic role labeling, and one of one or third more natural language phrases based on an abstract meaning representation;
filter the plurality of domain content sentences for at least one of a sequence-to-sequence model and a language model; and
prepare a training dataset with a plurality of phrases of different length and an expected next word, wherein the plurality of phrases and the next word are not directly extracted from the plurality of domain content sentences.

12. The computer program product of claim 8, wherein sort the one or more predicted phrases, wherein the one or more predicted phrases are sorted based on the similarity computation between the one or more predicted phrases and the corpus of documents for the specific domain further comprises one or more of the following program instructions, stored on the one or more computer readable storage media, to:
receive one or more first predictions from a first system and one or more second predictions from a second system;
normalize a first score for each first prediction of the one or more first predictions and a second score for each second prediction of the one or more second predictions;
create a plurality of prediction pairs, wherein each prediction pair includes a first prediction from the one or more first predictions and a second prediction from the one or more second predictions;
calculate a combined string similarity for each prediction pair of the plurality of prediction pairs based on the first score and the second score, wherein the string similarity is calculated using at least one of approximate matching and phrase similarity;
calculate a prediction weight, wherein the prediction weight is a mean of the combined string similarity for each prediction pair of the plurality of prediction pairs;
multiply a first normalized score of each first prediction of the one or more first predictions by the prediction weight to create a first weighted score for each first prediction;
multiply a second normalized score of each second prediction of the one or more second predictions by the prediction weight to create a second weighted score for each second prediction; and
merge the one or more first predictions and the one or more second predictions into a prediction list, wherein the prediction list is sorted based on a descending order of the first weighted score and the second weighted score.

13. The computer program product of claim 8, wherein sort the one or more predicted phrases, wherein the one or more predicted phrases are sorted based on the similarity computation between the one or more predicted phrases and the corpus of documents for the specific domain further comprises one or more of the following program instructions, stored on the one or more computer readable storage media, to:
convert each document in the corpus of documents into a fixed length floating point vector, wherein the conversion is performed using a text encoder;
calculate a vector similarity for each document in the corpus of documents, wherein the vector similarity is a similarity computation between the one or more predicted phrases and the fixed length floating point vector; and
select one or more top query predictions, wherein the one or more top query predictions are the one or more predicted phrases that have a highest similarity based on the vector similarity.

14. The computer program product of claim 8, further comprising one or more of the following program instructions, stored on the one or more computer readable storage media, to:
select a subset of the one or more predicted phrases, wherein a size of the subset is a predetermined number; and
send the subset of the one or more predicted phrases to a user.

15. A computer system for predictive auto completion, the computer system comprising:
one or more computer processors;
one or more computer readable storage media; and
program instructions stored on the one or more computer readable storage media for execution by at least one of the one or more computer processors, the stored program instructions including instructions to:
receive an input phrase for an inquiry, wherein the input phrase is a sequence of words;
predict one or more next words for the input phrase, wherein the prediction is based on a deep neural network model that has been trained with a corpus of documents for a specific domain;
append the one or more next words to the input phrase to create one or more predicted phrases; and
sort the one or more predicted phrases, wherein the one or more predicted phrases are sorted based on a similarity computation between the one or more predicted phrases and the corpus of documents for the specific domain.

16. The computer system of claim 15, wherein append the one or more next words to the input phrase to create the one or more predicted phrases comprises one or more of the following program instructions, stored on the one or more computer readable storage media, to:
determine whether any next word of the one or more next words for the input phrase is an end of sentence, wherein the end of sentence denotes that a specific phrase of the one or more predicted phrases is complete;
responsive to determining that any specific phrase of the one or more predicted phrases is complete, store the completed any specific phrase in a list of completed phrases;
responsive to determining that any specific phrase of the one or more predicted phrases is not complete, append the one or more next words to the any specific phrase of the one or more predicted phrases that is not complete; and
predict one or more next words for the any specific phrase of the one or more predicted phrases that is not complete.

17. The computer system of claim 15, wherein predict the one or more next words for the input phrase, wherein the prediction is based on the deep neural network model that has been trained with the corpus of documents for the specific domain further comprises one or more of the following program instructions, stored on the one or more computer readable storage media, to:
generate training data from a plurality of sentences in the corpus of documents for the specific domain;
create a word vector representation for each word of one or more words in a training phrase;
input the word vector representation for each word of one or more words in the training phrase into a deep learning sequence model to create a phrase vector representation of the training phrase; and
input the phrase vector representation of the training phrase into the deep neural network model.

18. The computer system of claim 17, wherein generate training data from the plurality of sentences in the corpus of documents for the specific domain further comprises one or more of the following program instructions, stored on the one or more computer readable storage media, to:
receive a plurality of domain content sentences from the corpus of documents from the specific domain;
extract the plurality of domain content sentences as at least one of one or more n-grams, one of one or more first natural language phrases based on a deep parsing, one of one or more second natural language phrases based on a semantic role labeling, and one of one or third more natural language phrases based on an abstract meaning representation;
filter the plurality of domain content sentences for at least one of a sequence-to-sequence model and a language model; and
prepare a training dataset with a plurality of phrases of different length and an expected next word, wherein the plurality of phrases and the next word are not directly extracted from the plurality of domain content sentences.

19. The computer system of claim 15, wherein sort the one or more predicted phrases, wherein the one or more predicted phrases are sorted based on the similarity computation between the one or more predicted phrases and the corpus of documents for the specific domain further comprises one or more of the following program instructions, stored on the one or more computer readable storage media, to:
receive one or more first predictions from a first system and one or more second predictions from a second system;
normalize a first score for each first prediction of the one or more first predictions and a second score for each second prediction of the one or more second predictions;
create a plurality of prediction pairs, wherein each prediction pair includes a first prediction from the one or more first predictions and a second prediction from the one or more second predictions;
calculate a combined string similarity for each prediction pair of the plurality of prediction pairs based on the first score and the second score, wherein the string similarity is calculated using at least one of approximate matching and phrase similarity;
calculate a prediction weight, wherein the prediction weight is a mean of the combined string similarity for each prediction pair of the plurality of prediction pairs;
multiply a first normalized score of each first prediction of the one or more first predictions by the prediction weight to create a first weighted score for each first prediction;
multiply a second normalized score of each second prediction of the one or more second predictions by the prediction weight to create a second weighted score for each second prediction; and
merge the one or more first predictions and the one or more second predictions into a prediction list, wherein the prediction list is sorted based on a descending order of the first weighted score and the second weighted score.

20. The computer system of claim 15, wherein sort the one or more predicted phrases, wherein the one or more predicted phrases are sorted based on the similarity computation between the one or more predicted phrases and the corpus of documents for the specific domain further comprises one or more of the following program instructions, stored on the one or more computer readable storage media, to:
convert each document in the corpus of documents into a fixed length floating point vector, wherein the conversion is performed using a text encoder;
calculate a vector similarity for each document in the corpus of documents, wherein the vector similarity is a similarity computation between the one or more predicted phrases and the fixed length floating point vector; and
select one or more top query predictions, wherein the one or more top query predictions are the one or more predicted phrases that have a highest similarity based on the vector similarity.
